(19) United States
(12) Patent Application Publication
(10) Pub. No.: US 2013/0094877 A1
(43) Pub. Date: Apr. 18, 2013

(54) IMAGE FORMING APPARATUS

(71) Applicant: CANON KABUSHIKI KAISHA, Tokyo (JP)

(72) Inventors: Satoshi Tsuji, Yokohama-shi (JP); Koichi Yamada, Suntou-gun (JP)

(73) Assignee: CANON KABUSHIKI KAISHA, Tokyo (US)

(21) Appl. No.: 13/647,663

(22) Filed: Oct. 9, 2012

(30) Foreign Application Priority Data
Oct. 13, 2011 (JP) 2011-226026

(51) Int. Cl. G03G 21/20

(52) U.S. Cl. 399/92

(57) ABSTRACT

In a period that a first mode is executed, an image forming apparatus blows air at a first amount of flowing air in a period during which a recording material is conveyed on a conveying path and before a leading edge of the recording material reaches a fixing unit, and blows air at a second amount of flowing air smaller than the first amount in a period during which the recording material passes through the fixing unit. In a period that a second mode is executed, the image forming apparatus blows air at a third amount of flowing air larger than the second amount for at least a period during which a recording material on which an image is formed passes through the fixing unit.

### BACKGROUND OF THE INVENTION

1. Field of the Invention

The present invention relates to an image forming apparatus that performs image formation on a recording material by an electrophotographic process such as a laser printer, a light-emitting diode (LED) printer, a digital copying machine, or the like and includes an air blowing unit such as a fan that cools an interior of the apparatus main body by blowing air.

2. Description of the Related Art

In such an apparatus, when the image forming operation (printing operation) is performed, the temperature in the apparatus rises by heat generated from internal devices. When the temperature in the apparatus rises, a toner within a developing container is heated, characteristics of the toner is deteriorated (fluidity is worsened), developability is degraded, and there is a fear that image defect such as decrease in density of images may occur. In addition, with respect to a cleaner including a cleaning member for cleaning a toner remained on a photosensitive member, the cleaning member is deteriorated by temperature rise in the apparatus, cleaning capability is lowered, and accordingly, there is a fear that the image defect may occur.

Since temperature of a sheet (recording material) heated by a fixing unit will be high, temperature of members such as a sheet guide, a sheet discharge sensor, a sheet discharge roller which are arranged on a downstream side of a fixing nip portion of the fixing unit in a sheet conveying direction are likely to rise. Thus, an issue of the image defect is likely to occur by deformation or damage of these members due to heat, adhesion of a fused toner to these members, or the like.

Japanese Patent Application Laid-Open No. 2005-77478 discusses a configuration for cooling a developing container, members on a downstream side of a fixing nip portion in a sheet conveying direction, and other members in the apparatus, by causing a fan to produce an air flow.

When passing through the fixing unit, a sheet is heated at the fixing nip portion and produces water vapor. However, if moisture amounts evaporated from a front side and a back side of the sheet are largely different, a difference of degrees of shrinkage between the front side and the back side of the sheet also becomes large, and as a result, the sheet may curl.

In the case of the configuration for cooling the members on the downstream side of the fixing nip portion in the sheet conveying direction as discussed in Japanese Patent Application Laid-Open No. 2005-77478, if in a state in which air flow is excessively produced in a sheet conveying path on the downstream side of the fixing nip portion in the sheet conveying direction during image formation, water vapor produced from the sheet is discharged by the air flow to the outside of the apparatus. At this time, since more water vapor will be lost from a side closer to an exhaust port between the front side and back side of the sheet by the air flow, a difference of moisture amounts lost from the front side and back side of the sheet becomes large, and the sheet is likely to curl. If the sheet curls, stackability of the sheet to be discharged and stacked on a sheet discharge tray is worsened, and there is a fear that paper jam may occur at a sheet discharge unit.

### SUMMARY OF THE INVENTION

The present invention relates to cooling an apparatus while suppressing occurrence of curl on a sheet in an image forming apparatus in which an air flow is produced by blowing air from an air blowing unit, in a portion on a downstream side of a fixing unit on a conveying path in a conveying direction.

According to an aspect of the present invention, an image forming apparatus includes a fixing unit configured to heat a recording material on which a toner image is formed, and to fix the toner image on the recording material, the fixing unit arranged on a conveying path in which the recording material on which the image is form is conveyed, an air blowing unit configured to produce an air flow in a portion on a conveying direction downstream side of the fixing unit of the conveying path by air blowing, and a control unit configured to control an amount of flowing air of the air flow produced in a portion on the conveying direction downstream side of the fixing unit of the conveying path. The image forming apparatus is capable of executing a first mode for forming an image on only one-side of a recording material and discharging the recording material, and a second mode for forming an image on two-sides of a recording material and discharging the recording material. The control unit, during a period the first mode is executed, with respect to a recording material on which an image is to be formed, controls the air blowing unit such that the amount of flowing air becomes a first amount of flowing air, for a period during which the recording material is conveyed on the conveying path, and before a leading edge of the recording material reaches the fixing unit, controls the air blowing unit such that the amount of flowing air becomes a second amount of flowing air smaller than the first amount of flowing air, for a period during which the recording material is passing through the fixing unit, and during a period the second mode is executed, controls the air blowing unit such that the amount of flowing air becomes a third amount of flowing air larger than the second amount of flowing air at least for a period during which a recording material on which an image is to be formed is passing through the fixing unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic cross-sectional view of an image forming apparatus.

FIG. 2 is an overhead view of the image forming apparatus.

FIG. 3 is a flowchart illustrating control of a cooling fan by a fan control unit.

FIG. 4 is a flowchart illustrating control of a cooling fan by a fan control unit.

FIG. 5 is a flowchart illustrating control of a cooling fan by a fan control unit.

FIG. 6A is a schematic cross-sectional view of the image forming apparatus. FIG. 6B is a cross-sectional view of a periphery of a cooling fan as seen from above when a blocking member is at a first position. FIG. 6C is a cross-sectional view of a periphery of the cooling fan as seen from above when the blocking member is at a second position.

FIG. 7 is a flowchart illustrating air blow control by an air blow control unit.

FIGS. 8A and 8B are schematic cross-sectional views of the image forming apparatus, respectively.

### DESCRIPTION OF THE EMBODIMENTS

Various exemplary embodiments, features, and aspects of the invention will be described in detail below with reference to the drawings.

### [Configuration of Image Forming Apparatus and Image Forming Operation]

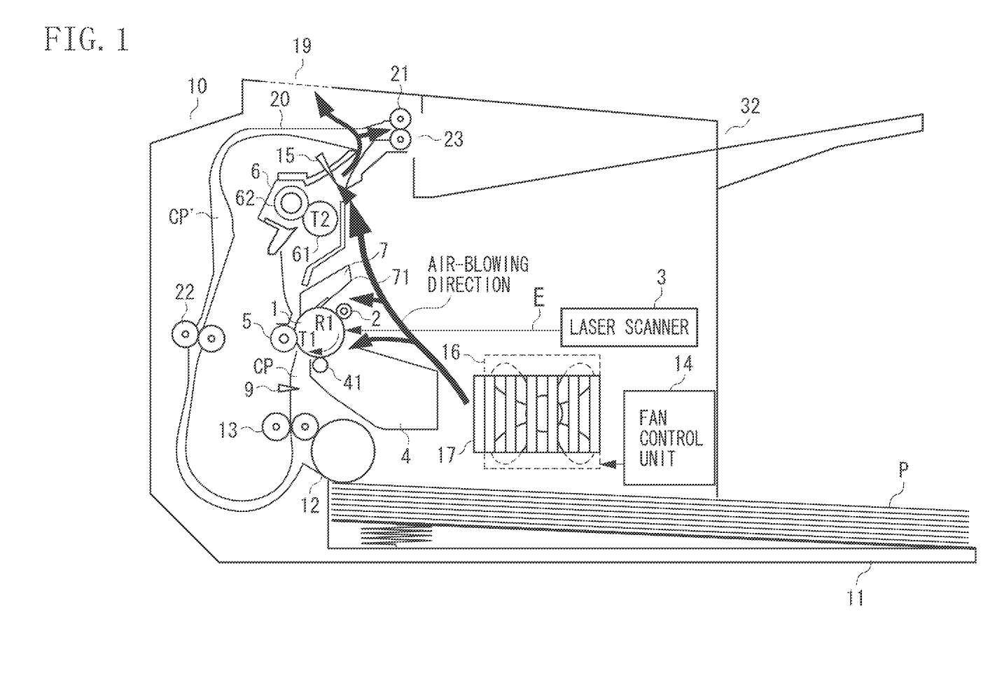

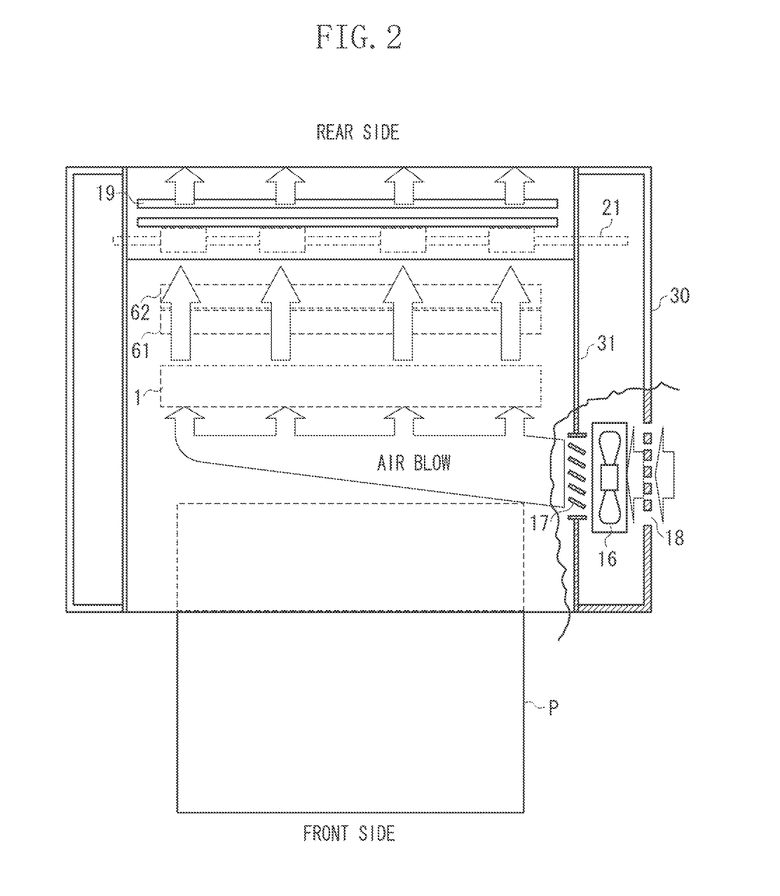

An image forming apparatus according to a first exemplary embodiment will be described. FIG. 1 is a schematic cross-sectional view of an image forming apparatus 10 as a laser printer that performs image formation on a sheet material P as a recording material. First, an image forming operation of the image forming apparatus 10 will be described.

The image forming apparatus 10 includes a photosensitive drum 1 as an image bearing member. The photosensitive drum 1 is rotationally driven by a driving unit (not illustrated) at a predetermined speed in a direction indicated by an arrow R1. Around the photosensitive drum 1, a charging roller (charging unit) 2, a laser scanner (exposure unit) 3, a developing container 4 including a developing roller (developing unit) 41, and a transfer roller (transfer unit) 5 are arranged as an image forming unit.

The surface of the rotationally driven photosensitive drum 1 is uniformly charged at a predetermined polarity and potential by the charging roller 2, and is irradiated with a laser beam according to image information by the laser scanner 3, and an electrostatic latent image is formed thereon. A toner is adhered to the electrostatic latent image by the developing roller 41, and a toner image is visualized. On the other hand, sheet materials P (sheets) accommodated in a sheet feed tray 11 are fed one by one by a sheet feeding roller 12 to a conveying path CP inside the apparatus main body 10. Then, the sheet material P is conveyed on the conveying path CP by a conveyance unit such as s conveyance roller 13 for conveying the sheet material P.

On the conveying path CP, a transfer nip portion (transfer unit) T1 formed between the photosensitive drum 1 and a transfer roller 5 is provided, and the sheet material P is conveyed to the transfer nip portion to match the timing to the toner image formed on the photosensitive drum 1. Then, the toner image on the photosensitive drum 1 is transferred onto the sheet material P by a transfer bias applied to the transfer roller 5.

A fixing device (fixing unit) 6 is provided on the downstream side of the conveying direction of the sheet material P in the conveying path CP, and a fixing nip portion (fixing unit) T2 formed by a fixing film 61 and a pressure roller 62 of the fixing device 6 is provided on the conveying path CP. The sheet material P onto which the toner image is transferred by passing through the transfer nip portion T1 is further conveyed to the fixing nip portion T2 via the conveying path CP. Further, the sheet material P is applied heat and pressure between the fixing film 61 and the pressure roller 62 at the fixing nip portion T2 while being conveyed in a sandwiched manner. Accordingly, the toner image is fixed onto the surface of the sheet material P. Then, the sheet material P is further conveyed via the conveying path CP by a sheet discharge roller 21, is discharged from a sheet discharge port 23 and stacked on a sheet discharge tray 32 formed on a top surface of the image forming apparatus 10.

On the other hand, the surface of the photosensitive drum 1, after passing through the transfer nip portion T1, is cleaned by a cleaning blade 71 of a cleaner (cleaning unit) 7, and a remained toner which is not transferred onto the sheet material P or the like are removed. Through the above-described operation, one-sided printing can be performed by performing image formation on only one-side of the sheet material P and discharging it to the outside the apparatus. The one-sided printing is performed by the image forming apparatus 10 executing a one-sided printing mode (first mode).

The conveying path CP is a space surrounded by a guide member for guiding conveyance of the sheet material P, and formed in the apparatus main body. In addition, the conveying path CP refers to a space extending from the sheet feeding roller 12 to the sheet discharge port 23. The sheet feeding roller 12, the conveyance roller 13, the photosensitive drum 1, the transfer roller 5, the fixing film 61, the pressure roller 62, and the sheet discharge roller 21 acts as a conveyance unit for conveying the sheet material P in the conveying path CP.

A top sensor (leading edge detection unit) 9 as a sheet material detection unit that detects the sheet material P is provided on the conveying path CP on a position on an upstream side of the transfer nip portion T1 and on a downstream side of the conveyance roller 13 in the conveying direction of the sheet material P. The top sensor 9 detects that the leading edge of the sheet material P conveyed toward the transfer nip portion T1 has passed through a position of the top sensor 9 on the conveying path CP.

In addition, a sheet discharge sensor (trailing edge detection unit) 15 as a sheet material detection unit is provided between the fixing nip portion T2 and the sheet discharge roller 21 on the conveying path CP. The sheet discharge sensor 15 detects that the trailing edge of the sheet material P conveyed toward the sheet discharge port 23 has passed through a position of the sheet discharge sensor 15 on the conveying path CP.

Next, two-sided printing for performing image formation on two-sides of the sheet material P will be described. When printing is performed on both front and back sides of the sheet material P, the printing operation is the same as the one-sided printing to the point where the sheet material P passes through the fixing nip portion T2. After passing through the fixing nip portion T2, the sheet material P is sent to the sheet discharge tray 32 side, and the leading edge portion is temporarily exposed from the sheet discharge port 23 to the outside of the apparatus main body 10 and stopped. Then, the sheet discharge roller 21 rotates in an opposite direction, the sheet material P is conveyed in a reverse direction within the conveying path CP, and is switchbacked by being conveyed into a two-sided conveying path CP′ via a two-sided reversing guide 20.

Then, the sheet material P is conveyed in the two-sided conveying path CP′ by the two-sided conveyance rollers 22, and enters again into the conveying path CP in a state in which the front and back sides have been reversed. The sheet material P passes through the transfer nip portion T1, and the fixing nip portion T2, in a similar manner to the one-sided printing, and the toner image is formed and fixed on an opposite surface of the side on which the toner image has been formed in the first time. Then, the sheet material P is discharged onto the sheet discharge tray 32. By the above operation, the two-sided printing can be performed by performing image formation on the two-sides of the sheet material P and discharging it to the outside of the apparatus. The two-sided printing is performed by the image forming apparatus 10 executing the two-sided printing mode (second mode).

The image forming apparatus 10 starts processing of a print job (an image forming job) by receiving a printing command from a host computer or the like. One print job is a unit for performing image formation based on one printing command, and a number of sheets of the recording materials on which image formation is performed is varied depending on data for performing image formation. Whether to perform one-sided printing or two-sided printing is set by the print job. When one print job is processed, if a number of the recording materials on which image formation is performed is a plurality of sheets, image formation on the plurality of sheets is performed continuously.

### [Airflow Path Configuration of Image Forming Apparatus]

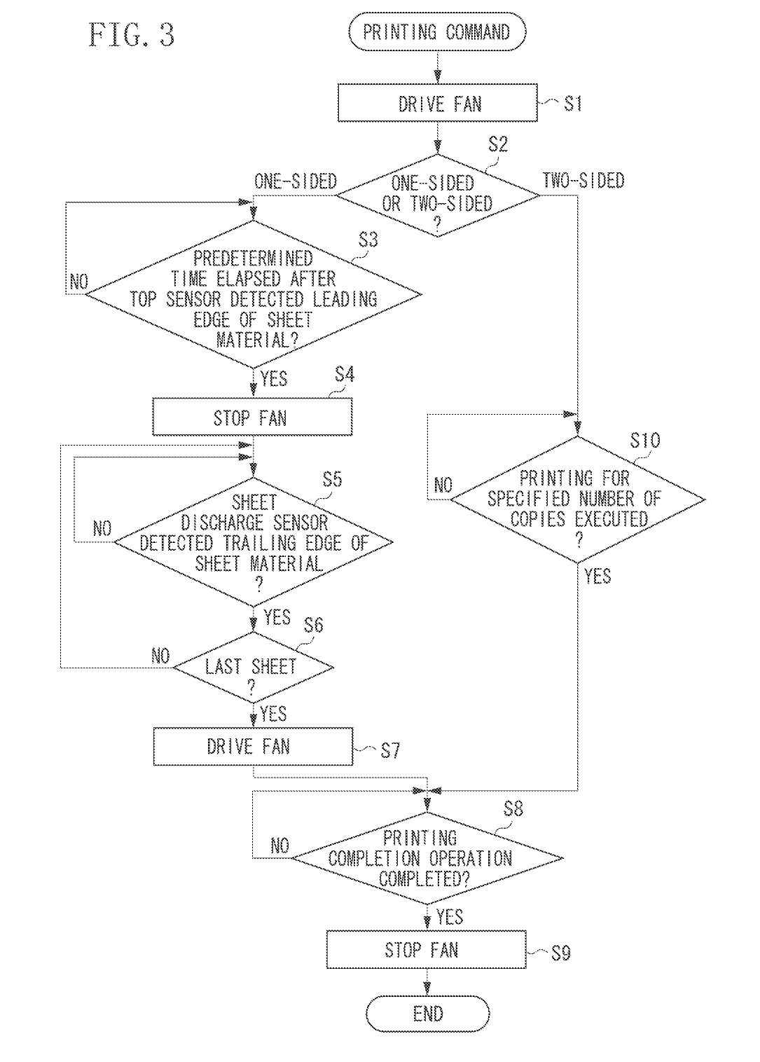

Next, an airflow path configuration of the image forming apparatus 10 will be described with reference to FIGS. 1 and 2. FIG. 2 is an overhead view of the image forming apparatus 10. In FIG. 2, some members are omitted for simplicity purpose. Further, a front side and a rear side of the apparatus illustrated in FIG. 2 respectively refer to a right-hand side and a left-hand side of the apparatus illustrated in FIG. 1.

When an image forming operation (printing operation) is performed, temperature in the apparatus rises and toners within the developing container 4 are heated by heat generated from the fixing unit, and accordingly there is a fear that toner characteristics maybe deteriorated (fluidity may be worsened), developability may be degraded, and image defects such as imaging density degradation may be caused. With respect to the cleaner provided with the cleaning blade 71, the cleaning blade 71 is deteriorated due to temperature rise in the apparatus, and cleaning capability falls, and there is a fear of causing image defects. In addition, since the temperature of the sheet material P heated by the fixing device 6 becomes high, temperature of the members such as the sheet guide, the sheet discharge sensor 15, the sheet discharge roller 21, and the like, which are arranged on the downstream side of the fixing nip portion T2 in the conveying direction of the sheet material P is likely to increase. Therefore, an issue of the image defect is likely to occur by deformation or damage of these members due to heat, adhesion of a fused toner to these members, or the like.

Consequently, the image forming apparatus according to the present exemplary embodiment includes a cooling fan 16 for producing an air flow into the apparatus main body on a side surface of the apparatus. Air from outside the apparatus is drawn into through an ambient air intake louver 18 (FIG. 2) provided on a main body outfit cover 30, and is blown into the apparatus via a louver 17 provided on a main body frame 31. Ambient air drawn into the apparatus by the cooling fan 16 passes through the louver 17 on which an opening is formed, is blown toward the developing container 4, the cleaner 7, and the fixing device 6 which are in the periphery of the photosensitive drum 1, and cools the respective devices.

By the air blow toward the fixing device 6, air flow is produced in a portion on a conveying direction (from below in an upward direction along the conveying path) downstream side of the sheet material P of the conveying path CP. By the air flow, the sheet discharge sensor 15, a member forming the conveying path CP to guide conveyance of the sheet, and the sheet discharge roller 21 are cooled. The air which has performed cooling by the air flow is discharged from the sheet discharge port 23 and an exhaust louver 19 to the outside of the apparatus.

### [Air Blow Control]

Next, air blow control of the cooling fan 16 will be specifically described. Operations such as driving and stopping of the cooling fan 16 are controlled by a fan control unit 14, and the fan control unit 14 acts as an airflow control unit (control unit) that controls an amount of flowing air of the air flow produced in a portion on the downstream side of the fixing nip portion T2 in the conveying direction of the conveying path CP.

Upon receiving a signal of the printing command, the fan control unit 14 starts driving of the cooling fan 16. By the start of printing, the sheet material P is fed to the sheet feeding roller 12, and is conveyed within the conveying path CP. After a leading edge of the sheet material P has passed through the conveyance roller 13, the fan control unit 14 stops the cooling fan 16 before the leading edge of the sheet material P enters into the fixing nip portion T2. Then, the sheet material P is conveyed and passes through the fixing nip portion T2. When the sheet material P trailing edge is detected by the sheet discharge sensor 15, the fan control unit 14 drives the cooling fan 16.

Next, the above-described control of the cooling fan 16 by the fan control unit 14 will be described in greater detail with reference to the flowchart in FIG. 3. First, in step S1, the fan control unit 14 starts processing of the print job according to the printing command, and at the same time, drives the cooling fan 16 such that its own amount of blown air becomes a first amount of blown air. In a state in which the cooling fan 16 is driven in this way, an air flow with a first amount of flowing air proportional to the first amount of blown air is produced in the portion on the downstream side of the fixing nip portion T2 in the conveying direction of the conveying path CP.

Next, in step S2, the fan control unit 14 determines whether the printing mode of the print job to be executed is a one-sided mode or a two-sided mode. In the image forming apparatus 10, in the case of the one-sided printing mode, the processing in the above-described one-sided printing mode is executed. In the case of the two-sided printing mode, the processing in the above-described two-sided printing mode is executed.

In the case of the one-sided printing mode, in step S3, the fan control unit 14 determines whether a predetermined time has elapsed after the leading edge of the fed sheet material P has been detected by the top sensor 9. If the predetermined time has elapsed (YES in step S3), in step S4, the cooling fan 16 is stopped. In this way, the fan control unit 14 stops the cooling fan 16 based on the predetermined time which is counted based on an output from the top sensor 9.

The predetermined time is set shorter than a time elapsed since the leading edge of the sheet material P has passed through the top sensor 9 until it reaches the fixing nip portion T2. Thus, the cooling fan 16 is stopped before the leading edge of the sheet material P reaches the fixing nip portion T2. An amount of blown air of the cooling fan 16 at this time is regarded as a second amount of blown air, and an amount of flowing air of an air flow produced in the portion on the downstream side of the fixing nip portion T2 in the conveying direction of the conveying path CP is regarded as a second amount of flowing air. In a state in which the cooling fan 16 is stopped in this way, the second amount of blown air is zero, and the second amount of flowing air also becomes substantially zero.

A time elapsed since the leading edge of the sheet material P has passed through the top sensor 9 until it reaches the fixing nip portion T2 is a value obtained by dividing a distance from the top sensor 9 to the fixing nip portion T2 on the conveying path CP by a conveyance speed of the sheet material P, and is a value determined depending on the conveyance speed of the sheet material P. Therefore, according to the present exemplary embodiment, the “predetermined time” is a value set according to the conveyance speed.

Next, in step S5, the fan control unit 14 determines whether the sheet discharge sensor 15 has detected the trailing edge of the sheet material P. If the trailing edge has been detected (YES in step S5), in step S6, the fan control unit 14 determines whether the sheet material P of which the trailing edge has been detected is a sheet (last sheet) corresponding to the last page of the print job.

If it is not the last sheet (NO in step S6), the cooling fan 16 remains stopped. Whereas if it is the last sheet (YES in step S6), in step S7, the cooling fan 16 is driven. At this time, the cooling fan 16 is driven so that amount of blown air of the cooling fan 16 is the first amount of blown air, and an air flow with the first amount of flowing air is produced in the portion on the downstream side of the fixing nip portion 12 in the conveying direction of the conveying path CP. In this way, the fan control unit 14 drives the cooling fan 16 based on an output from the sheet discharge sensor 15.

Then, in step S8, the fan control unit 14 determines whether an after-printing operation such as after-printing rotation or the like is completed. If the after-printing operation is completed (YES in step S8), in step S9, the cooling fan 16 is stopped.

If the case of the two-sided printing mode, the two-sided printing mode is executed while maintaining the amount of blown air of the cooling fan 16 driven in the above-described step S1 at the first amount of blown air. In other words, an air flow with the first amount of flowing air is produced in the portion on the downstream side of the fixing nip portion T2 in the conveying direction of the conveying path CP.

Then, in step S10, the fan control unit 14 determines whether printing has been executed until the number of print copies of the print job reaches a specified number. If the printing has been executed to the specified number (YES in step S10), in step S8, it is determined whether the after-printing operation is completed. If the after-printing operation is completed (YES in step S8), in step S9, the cooling fan 16 is stopped.

By performing the above-described control, in the one-sided printing mode, at least during a period in which the sheet material P passes through the fixing nip portion T2, the cooling fan 16 is stopped. During a period in which the cooling fan 16 is stopped, an air flow is little produced in the portion on the downstream side of the fixing nip portion T2 in the conveying direction of the conveying path CP. Therefore, water vapor produced from the sheet material P is more difficult to be discharged to the outside of the apparatus, as compared with a case where the air flow is produced. Accordingly, a difference of moisture amounts lost from the front side and the back side of the sheet becomes small, and the sheet is hardly likely to curl.

Further, in the case of the two-sided printing, the cooling fan 16 is continuously driven at the first amount of blown air during a printing operation period. This is because, in the two-sided printing, since the sheet after once having passed through the fixing unit, once again passes through the fixing unit with front and back sides being reversed, moisture amounts finally lost from the front side and the back side of the sheet are not so different, as compared with the one-sided printing, and thus the sheet is hardly likely to curl.

According to the present exemplary embodiment, the cooling fan 16 is driven at the first amount of blown air at any time during the two-sided printing mode. However, at least during the period in which the sheet material P passes through the fixing nip portion T2, it is only necessary to drive the cooling fan 16 at a third amount of blown air (which is larger than the second amount of blown air and includes the first amount of blown air) which can produce an air flow with a third amount of flowing air larger than the second amount of flowing air in the portion on the downstream side of the fixing nip portion T2 in the conveying direction of the conveying path CP.

Consequently, for example, after it is determined that the printing mode is the two-sided mode in step S2, the fan control unit 14 determines whether the predetermined time has elapsed after the leading edge of the fed sheet material P has been detected by the top sensor 9. If the predetermined time has elapsed, the cooling fan 16 is driven at the third amount of blown air. Then, it is determined whether the sheet discharge sensor 15 has detected the trailing edge of the sheet material P. If the sheet discharge sensor 15 has detected the trailing edge, the cooling fan 16 may be driven again at the first amount of blown air. Further, if it is other than a period during which the sheet material P passes through the fixing nip portion T2 at the time of execution of the two-sided printing mode, driving of the cooling fan 16 may be temporarily stopped or the amount of blown air may be reduced than the first amount of blown air.

As described above, according to the present exemplary embodiment, the air blow by the cooling fan 16 is stopped at least for a period during which the sheet material P is likely to curl if the air blow is performed by the cooling fan 16, namely, for a period during which the sheet material P passes through the fixing nip portion T2, during the printing operation period (during a period from reception of the printing command to completion of the after-printing operation) in the one-sided printing.

Further, the cooling fan 16 is driven before the first sheet of the job reaches the fixing nip portion T2, and after the trailing edge of the last sheet of the job has passed through the sheet discharge sensor, during the printing operation period. By this operation, the apparatus can be cooled by driving the cooling fan 16 as long hours as possible. Therefore, in the image forming apparatus including the air blowing unit for producing an air flow in the sheet conveying path on the downstream side of the fixing nip portion in the sheet conveying direction, the apparatus can be cooled while suppressing occurrence of curl on the sheet.

Further, in a case where the cooling fan 16 is configured to cool the image forming members (the developing container 4, and the cleaner 7) other than the fixing device 6 in the apparatus main body, the temperature rise of the apparatus can be suppressed by driving the cooling fan 16 as far as possible during the printing operation period. Consequently, by performing the control of the cooling fan 16 as described above, it is possible to strike a balance between cooling in the apparatus and suppressions of curl.

Further, according to the present exemplary embodiment, the cooling fan 16 is a fan for drawing air into the apparatus main body. However, an exhaust fan for exhausting air to the outside of the apparatus main body can obtain similar effect by similarly controlling an amount of blown air to be exhausted to the outside of the apparatus main body.

Next, a second exemplary embodiment will be described. The configuration of the image forming apparatus and the airflow path configuration according to the present exemplary embodiment are similar to those in the first exemplary embodiment. In the present exemplary embodiment, descriptions will be made of control of the cooling fan 16 by the fan control unit 14 in a case of intermittent sheet feeding in which a sheet feeding interval (sheet interval) between the two successive sheet materials P is wide in one print job.

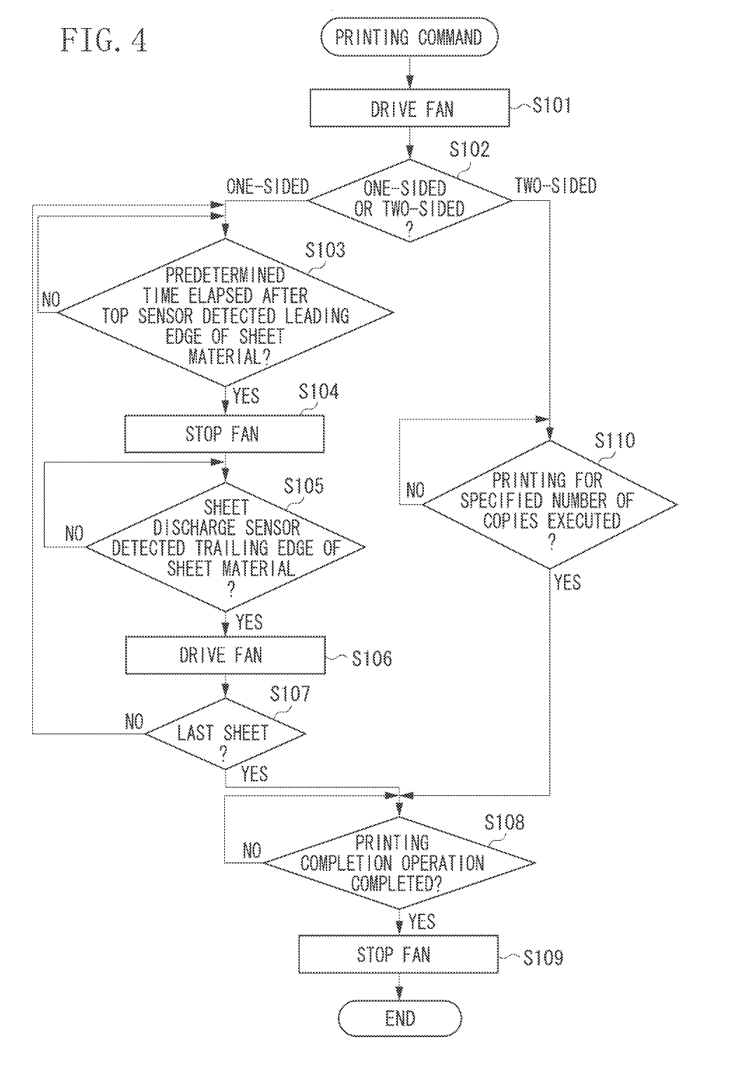

FIG. 4 is a flowchart illustrating the details of control. First, in step S101, when processing of the job is started according to the printing command, the fan control unit 14 starts driving of the cooling fan 16 at the first amount of blown air. At this time, an air flow with the first amount of flowing air is produced in the portion on the downstream side of the fixing nip portion T2 in the conveying direction of the conveying path CP.

Then, in step S102, the fan control unit 14 determines whether the printing mode of the print job to be executed is the one-sided mode or the two-sided mode. In the image forming apparatus 10, in the case of the one-sided printing mode, the processing in the above-described one-sided printing mode is executed. In the case of the two-sided printing mode, the processing in the above-described two-sided printing mode is executed.

In the case of the one-sided printing mode, in step S103, the fan control unit 14 determines whether the predetermined time has elapsed after the leading edge of the fed sheet material P is detected by the top sensor 9. If the predetermined time has elapsed (YES in step S103), in step S104, the cooling fan 16 is stopped. At this time, an amount of blown air of the cooling fan 16 itself is the second amount of blown air, or zero. At this time, an amount of flowing air of the air flow produced in the portion on the downstream side of the fixing nip portion T2 in the conveying direction of the conveying path CP is the second amount of flowing air and substantially zero.

The predetermined time, similar to the first exemplary embodiment, is shorter than a time length since the leading edge of the sheet material P has passed through the top sensor 9 until it reaches the fixing nip portion T2, and is a value to be set according to the conveyance speed.

Then, in step S105, the fan control unit 14 determines whether the sheet discharge sensor 15 has detected the trailing edge of the sheet material P. If the trailing edge has been detected (YES in step S105), in step S106, the fan control unit 14 starts to drive the cooling fan 16. At this time, in a state in which the cooling fan 16 is driven, an air flow with the first amount of flowing air is produced in the portion on the downstream side of the fixing nip portion T2 in the conveying direction of the conveying path CP.

Next, in step S107, the fan control unit 14 determines whether the sheet material P of which trailing edge has been detected is the last sheet which is the sheet corresponding to the last page of the print job. If it is not the last sheet (NO in step S107), the cooling fan 16 continues to drive, and when the predetermined time has elapsed after the leading edge of the next sheet material P has been detected by the top sensor 9, the cooling fan 16 is stopped. At this time, an amount of flowing air (second amount of flowing air) of the air flow produced in the portion on the downstream side of the fixing nip portion T2 in the conveying direction of the conveying path CP becomes substantially zero.

Then, in step S105, the fan control unit 14 determines whether the sheet discharge sensor 15 has detected the trailing edge of the sheet material P. If the trailing edge has been detected (YES in step S105), in step S106, the fan control unit 14 starts to drive the cooling fan 16. At this time, in a state in which the cooling fan 16 is driven, the air flow with the first amount of flowing air is produced in the portion on the downstream side of the fixing nip portion T2 in the conveying direction of the conveying path CP. The operation is repeated until the last sheet is processed.

If it is the last sheet (YES in step S107), in step S108, the fan control unit 14 determines whether the after-printing operation such as after-printing rotation or the like is completed. If the after-printing operation is completed (YES in step S108), in step S109, the cooling fan 16 is stopped.

In the case of the two-sided printing mode, the two-sided printing mode is executed while maintaining the amount of blown air of the cooling fan 16 driven in the above-described step S101 at the first amount of blown air. In other words, the air flow with the first amount of flowing air is produced in the portion on the downstream side of the fixing nip portion T2 in the conveying direction of the conveying path CP.

Then, in step S110, the fan control unit 14 determines whether printing has been executed until the number of print copies of the print job reaches the specified number. If the printing has been executed to the specified number (YES in step S110), in step S108, it is determined whether the after-printing operation is completed. If it is completed (YES in step S108), in step S109, the cooling fan 16 is stopped.

According to the present exemplary embodiment, the cooling fan 16 is driven at the first amount of blown air at any time during the two-sided printing mode. However, at least during the period in which the sheet material P passes through the fixing nip portion T2, it is only necessary to drive the cooling fan 16 at the third amount of blown air (which is larger than the second amount of blown air and includes the first amount of blown air) which can produce the air flow with the third amount of flowing air larger than the second amount of flowing air in the portion on the downstream side of the fixing nip portion T2 in the conveying direction of the conveying path CP.

Consequently, for example, after it is determined that the printing mode is the two-sided mode in step S102, the fan control unit 14 determines whether the predetermined time has elapsed after the leading edge of the fed sheet material P has been detected by the top sensor 9. If the predetermined time has elapsed, the cooling fan 16 is driven at the third amount of blown air. Then, it is determined whether the sheet discharge sensor 15 has detected the trailing edge of the sheet material P. If the sheet discharge sensor 15 has detected the trailing edge, the cooling fan 16 may be driven again at the first amount of blown air. Further, if it is other than a period during which the sheet material P passes through the fixing nip portion T2 at the time of execution of the two-sided printing mode, driving of the cooling fan 16 may be temporarily stopped or the amount of blown air may be reduced than the first amount of blown air.

As described above, according to the present exemplary embodiment, when a print job for performing image formation on a plurality of recording materials in one-sided printing is executed, the air blow by the cooling fan 16 is stopped at least for a period during which the sheet material P is likely to curl if the air blow is performed by the cooling fan 16, namely, for a period during which the sheet material P passes through the fixing nip portion T2, during the printing operation period.

Further, the cooling fan 16 is driven before the first sheet of the job reaches the fixing nip portion T2, and after the trailing edge of the last sheet of the job has passed through the sheet discharge sensor, during the printing operation period. Furthermore, the cooling fan 16 is also driven during a period since the leading edge of the next sheet has been detected by the top sensor 9 after the trailing edge of the sheet has passed through the sheet discharge sensor until the predetermined time has elapsed (before reaching the fixing nip portion T2). Therefore, even in the print job in which there is a certain level of interval between the sheets, a time period in which the cooling fan 16 is driven is increased as far as possible.

Therefore, in the image forming apparatus including the air blowing unit for producing an air flow in the sheet conveying path on the downstream side of the fixing nip portion in the sheet conveying direction, the apparatus can be cooled while suppressing occurrence of curl on the sheet.

Next, a third exemplary embodiment will be described. The configuration of the image forming apparatus and the airflow path configuration according to the present exemplary embodiment are similar to those in the first exemplary embodiment and the second exemplary embodiment. According to the first exemplary embodiment, when the sheet material P passes through the fixing nip portion 12, the cooling fan 16 is stopped. In contrast, in the present exemplary embodiment, it is configured, instead of stopping the cooling fan 16, to drive the cooling fan 16 by reducing the amount of blown air to an extent such that an air flow produced in the portion on the downstream side of the fixing nip portion T2 in the conveying direction of the conveying path CP does not substantially exert an influence on curl of the sheet.

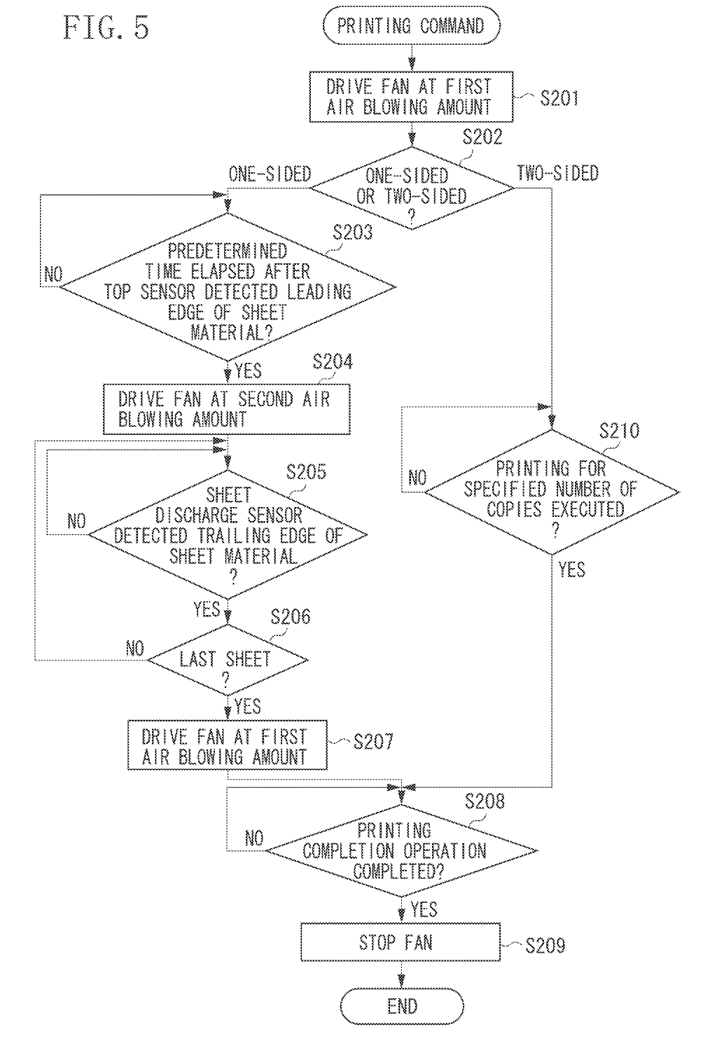

Next, control of the cooling fan 16 by the fan control unit 14 according to the present exemplary embodiment will be described in greater detail with reference to the flowchart in FIG. 5. First, in step S201, the fan control unit 14 starts processing of the print job according to the printing command, and at the same time, drives the cooling fan 16 at the first amount of blown air. At this time, an air flow with the first amount of flowing air is produced in the portion on the downstream side of the fixing nip portion T2 in the conveying direction of the conveying path CP.

Next, in step S202, the fan control unit 14 determines whether the printing mode of the print job to be executed is the one-sided mode or the two-sided mode. In the image forming apparatus 10, in the case of the one-sided printing mode, the processing in the above-described one-sided printing mode is executed. In the case of the two-sided printing mode, the processing in the above-described two-sided printing mode is executed.

In the case of the one-sided printing mode, in step S203, the fan control unit 14 determines whether the predetermined time has elapsed after the leading edge of the fed sheet material P has been detected by the top sensor 9. If the predetermined time has elapsed (YES in step S203), in step S204, the cooling fan 16 is driven at the second amount of blown air which is smaller than the first amount of blown air. In the state in which the cooling fan 16 is driven at the second amount of blown air, the air flow with the second amount of flowing air is produced in the portion on the downstream side of the fixing nip portion T2 in the conveying direction of the conveying path CP. However, the second amount of flowing air is an amount which does not substantially exert an influence on curl of the sheet material P. The predetermined time, similar to the first exemplary embodiment, is shorter than a time length since the leading edge of the sheet material P has passed through the top sensor 9 until it reaches the fixing nip portion T2, and is a value to beset according to the conveyance speed.

Next, in step S205, the fan control unit 14 determines whether the sheet discharge sensor 15 has detected the trailing edge of the sheet material P. If the trailing edge has been detected (YES in step S205), in step S206, the fan control unit 14 determines whether the sheet material P of which the trailing edge has been detected is a sheet (last sheet) corresponding to the last page of the print job. If it is not the last sheet (NO in step S206), the cooling fan 16 continues to drive at the second amount of blown air.

If it is the last sheet (YES in step S206), in step S207, the cooling fan 16 is driven at the first amount of blown air. At this time, an air flow with the first amount of flowing air is produced in the portion on the downstream side of the fixing nip portion T2 in the conveying direction of the conveying path CP.

Then, in step S208, the fan control unit 14 determines whether the after-printing operation such as after-printing rotation or the like is completed. If the after-printing operation is completed (YES in step S208), in step S209, the cooling fan 16 is stopped.

If the case of the two-sided printing mode, the two-sided printing mode is executed while maintaining the amount of blown air of the cooling fan 16 driven in the above-described step S201 at the first amount of blown air. In other words, the air flow with the first amount of flowing air is produced in the portion on the downstream side of the fixing nip portion T2 in the conveying direction of the conveying path CP.

Then, in step S210, the fan control unit 14 determines whether printing has been executed until the number of print copies of the print job reaches the specified number. If the printing has been executed to the specified number (YES in step S210), in step S208, it is determined whether the after-printing operation is completed. If the after-printing operation is completed (YES in step S208), in step S209, the cooling fan 16 is stopped.

In the case of the two-sided printing mode, at least during the period in which the sheet material P passes through the fixing nip portion T2, it is only necessary to drive the cooling fan 16 at the third amount of blown air (which is larger than the second amount of blown air and includes the first amount of blown air) which can produce the air flow with the third amount of flowing air larger than the second amount of flowing air in the portion on the downstream side of the fixing nip portion T2 in the conveying direction of the conveying path CP.

Consequently, for example, after it is determined that the printing mode is the two-sided mode in step S202, the fan control unit 14 determines whether the predetermined time has elapsed after the leading edge of the fed sheet material P has been detected by the top sensor 9. If the predetermined time has elapsed, the cooling fan 16 is driven at the third amount of blown air. Then, it is determined whether the sheet discharge sensor 15 has detected the trailing edge of the sheet material P. If the sheet discharge sensor 15 has detected the trailing edge, the cooling fan 16 may be driven again at the first amount of blown air. Further, if it is other than a period during which the sheet material P passes through the fixing nip portion T2 at the time of execution of the two-sided printing mode, driving of the cooling fan 16 may be temporarily stopped or the amount of blown air may be reduced than the first amount of blown air.

By performing the control as described above, in the one-sided printing mode, at least during a period in which the sheet material P passes through the fixing nip portion T2, the cooling fan 16 is driven at the second amount of blown air which exerts substantially no influence on curl of the sheet. Therefore, an air flow is hardly likely to be produced in the portion on the downstream side of the fixing nip portion T2 in the conveying direction of the conveying path CP. Therefore, water vapor produced from the sheet material P is more difficult to be discharged to the outside of the apparatus, as compared with a case where the air flow is produced. Accordingly, a difference of moisture amounts lost from the front side and the back side of the sheet becomes small, and the sheet is hardly likely to curl.

Further, in the case of the two-sided printing, since the curl is hardly likely to be generated similarly to the first exemplary embodiment, thus the cooling fan 16 is continuously driven at the first amount of blown air during the printing operation period.

As described above, according to the present exemplary embodiment, at least for a period during which the sheet material P is likely to curl if the air blow is performed by the cooling fan 16, namely, for a period during which the sheet material P passes through the fixing nip portion T2, in the printing operation period (during a period from reception of the printing command to completion of the after-printing operation) of the one-sided printing, the amount of blown air of the cooling fan 16 is suppressed to the second amount of blown air enough to exert no influence on the curl of the sheet material P.

Further, the cooling fan 16 is driven at the first amount of blown air to cool the apparatus as far as possible, before the first sheet of the job reaches the fixing nip portion T2, and after a trailing edge of the last sheet of the job has passed through the sheet discharge sensor, during the printing operation period. Therefore, in the image forming apparatus including the air blowing unit for producing an air flow in the sheet conveying path on the downstream side of the fixing nip portion in the sheet conveying direction, the apparatus can be cooled while suppressing occurrence of curl on the sheet, without the need to stop the cooling fan 16.

In addition, for example, in the case of a print job in which there is a certain level of interval between the sheets, the cooling fan 16 may be driven at the first amount of blown air during a period since the leading edge of the next sheet material P has been detected by the top sensor 9 after the trailing edge of the sheet material P has passed through the sheet discharge sensor until the predetermined time has elapsed, as in the case of the second exemplary embodiment.

Next, a fourth exemplary embodiment will be described. The same reference numerals are assigned to parts similar to those in the above-described first through third exemplary embodiments, and descriptions thereof will not be repeated.

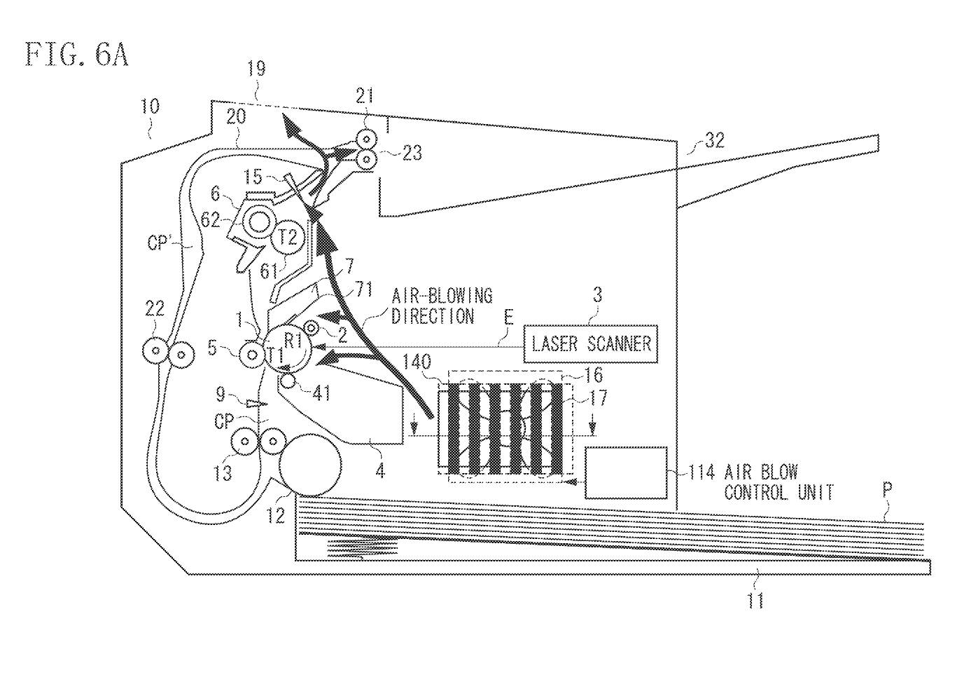

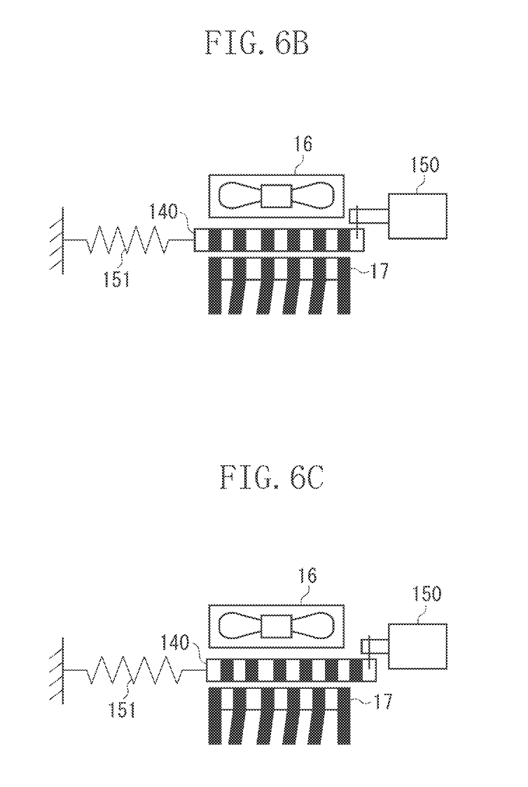

FIG. 6A is a schematic cross-sectional view of an image forming apparatus 10 according to the present exemplary embodiment. FIGS. 6B and 6C are cross-sectional views of periphery of the cooling fan 16 as seen from above the apparatus. FIG. 6B illustrates a state when a blocking member 140 is at the first position, and FIG. 6C illustrates a state when the blocking member 140 is at the second position.

In the first through third exemplary embodiments, the amount of blown air of the cooling fan 16 is controlled by driving or stopping the cooling fan 16 itself according to the printing operation or driving at an amount of blown air which exerts substantially no influence on the curl of the sheet. In contrast, according to the present exemplary embodiment, air blowing into a portion on the downstream side of the fixing nip portion T2 in the conveying direction of the conveying path CP by the cooling fan 16 is restricted by moving a blocking member (restricting member) 140 to block an opening of a louver 17 for drawing the ambient air suctioned by the cooling fan 16 into the apparatus.

The blocking member 140 is pulled by a spring 151, and in a state in which a solenoid 150 is not energized as illustrated in FIG. 6B, the blocking member 140 is placed on a first position at which the blocking member 140 does not block (restrict) wind from the louver 17. When the cooling fan 16 is driven in this state, air is blown toward the development device 4, the cleaning device 7, and the fixing device 6 in the periphery of the photosensitive drum 1 in the apparatus in a similar manner to the first exemplary embodiment.

The air blown toward the fixing device 6 produces an air flow with the first amount of flowing air in the portion on the downstream side in the sheet conveying direction of the conveying path CP (direction from downstream to upstream of the conveying path). In this state, the cooling fan 16 is driven at the first amount of blown air. The air flow mainly cools the sheet discharge sensor 15 arranged just behind the fixing nip portion T2, a member that forms the conveying path CP and guides conveyance of the sheets, and the like. Then, the air flow is discharged from the sheet discharge port 23 and the exhaust louver 19 to the outside of the apparatus.

When the solenoid 150 is energized, the blocking member 140 is moved from the first position to a second position at which the blocking member 140 blocks (restricts) wind from the louver 17 as illustrated in FIG. 6C. In this state, the air flow in the apparatus main body produced by the air blown from the cooling fan 16 is blocked (restricted). Therefore, if the cooling fan 16 is driven at the first amount of blown air, an amount of flowing air (second amount of flowing air) of the air flow produced in the portion on the downstream side of the fixing nip portion T2 in the conveying direction of the conveying path CP becomes substantially zero. In this way, the blocking member 140 moves between the first position and the second position by energization or energization cancelation of the solenoid.

The above-described control of the cooling fan 16 and the solenoid 150 is performed based on a signal from an air blow control unit 114. The air blow control unit 114 acts as an amount of flowing air control unit that controls an amount of flowing air of an air flow produced in the portion on the downstream side of the fixing nip portion T2 in the conveying direction of the conveying path CP.

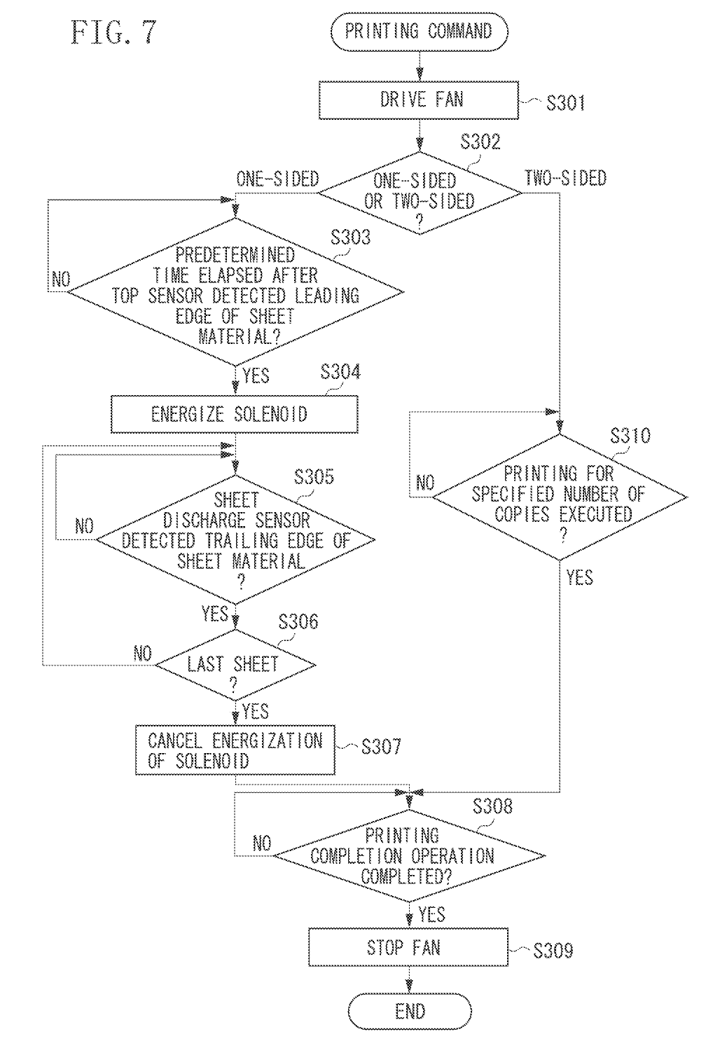

Next, specific air blow control by the air blow control unit 114 will be described. FIG. 7 is a flowchart illustrating the air blow control by the air blow control unit. First, in step S301, when processing of the job is started according to the printing command, the air blow control unit 114 starts driving of the cooling fan 16. At this time, an air flow with the first amount of flowing air is produced in the portion on the downstream side of the fixing nip portion T2 in the conveying direction of the conveying path CP.

Then, in step S302, the air blow control unit 114 determines whether the printing mode of the print job to be executed is the one-sided mode or the two-sided mode. In the image forming apparatus 10, in the case of the one-sided printing mode, the processing in the above-described one-sided printing mode is executed. In the case of the two-sided printing mode, the processing in the above-described two-sided printing mode is executed.

In the case of the one-sided printing mode, in step S303, the air blow control unit 114 determines whether a predetermined time has elapsed after the leading edge of the fed sheet material P has been detected by the top sensor 9. If the predetermined time has elapsed (YES in step S303), in step S304, the solenoid 150 is turned on. At this time, the amount of flowing air (the second amount of flowing air) of the air flow produced in the portion on the downstream side of the fixing nip portion T2 in the conveying direction of the conveying path CP becomes substantially zero.

Then, in step S305, the air blow control unit 114 determines whether the sheet discharge sensor 15 has detected the trailing edge of the sheet material P. If the trailing edge has been detected (YES in step S305), in step S306, the air blow control unit 114 determines whether the sheet material P is the last sheet corresponding to the last page of the job. If it is not the last sheet (NO in step S306), the solenoid 150 remains in an energized state (ON). Whereas if it is the last sheet (YES in step S306), in step S307, energization of the solenoid 150 is canceled (OFF). At this time, the air flow with the first amount of flowing air is produced in the portion on the downstream side of the fixing nip portion T2 in the conveying direction of the conveying path CP.

Then, in step S308, the air blow control unit 114 determines whether the after-printing operation such as after-printing rotation or the like is completed. If the after-printing operation is completed (YES in step S308), in step S309, the cooling fan 16 is stopped.

In the case of the two-sided printing mode, the two-sided printing mode is executed while the cooling fan 16, which has been driven in the above-described step S301 without energizing the solenoid 150, remains driven at the first amount of blown air. Therefore, an amount of flowing air of the air flow produced in the portion on the downstream side of the fixing nip portion T2 in the conveying direction of the conveying path CP is the first amount of flowing air.

Then, in step S310, the air blow control unit 114 determines whether printing has been executed until the number of print copies of the print job reaches a specified number. If the printing has been executed to the specified number (YES in step S310), in step S308, it is determined whether the after-printing operation is completed. If the print completion operation is completed (YES in step S308), in step S309, the cooling fan 16 is stopped.

According to the present exemplary embodiment, the cooling fan 16 is driven at the first amount of blown air at anytime during the two-sided printing mode. However, at least during the period in which the sheet material P passes through the fixing nip portion T2, the cooling fan 16 may be driven at the third amount of blown air (including the first amount of blown air) which can produce the air flow with the third amount of flowing air larger than the second amount of flowing air in the portion on the downstream side of the fixing nip portion T2 in the conveying direction of the conveying path CP.

Consequently, for example, after it is determined that the printing mode is the two-sided mode in step S302, the air blow control unit 114 determines whether the predetermined time has elapsed after the leading edge of the fed sheet material P has been detected by the top sensor 9. If the predetermined time has elapsed, the cooling fan 16 is driven at the third amount of blown air. Then, the air blow control unit 114 determines whether the sheet discharge sensor 15 has detected the trailing edge of the sheet material P. If the sheet discharge sensor 15 has detected the trailing edge, the cooling fan 16 may be driven again at the first amount of blown air. Further, if it is other than a period during which the sheet material P passes through the fixing nip portion T2 at the time of execution of the two-sided printing mode, driving of the cooling fan 16 may be temporarily stopped or the amount of blown air may be reduced than the first amount of blown air.

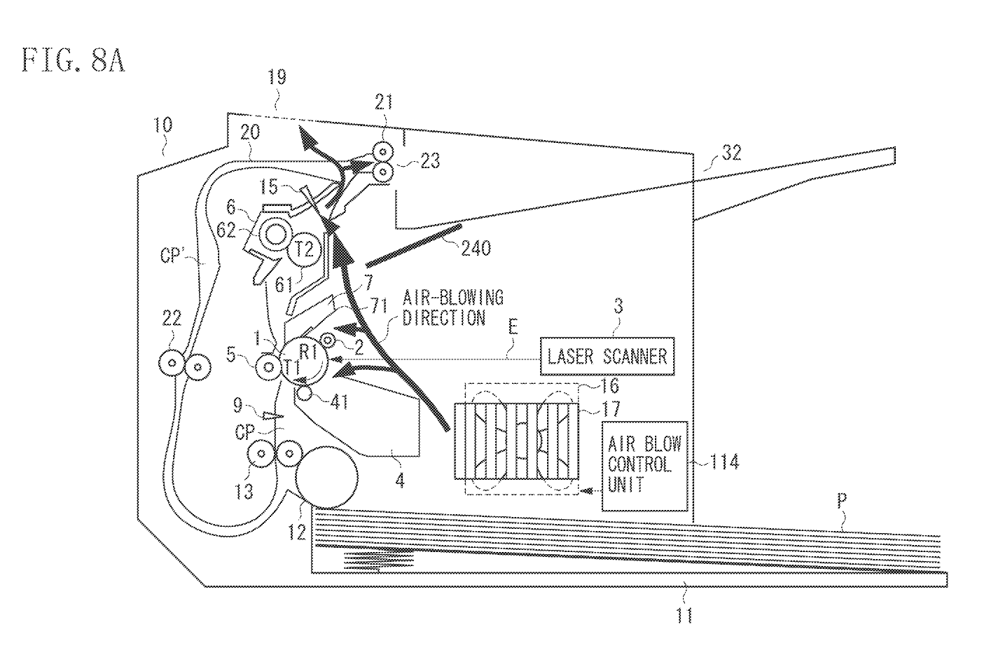

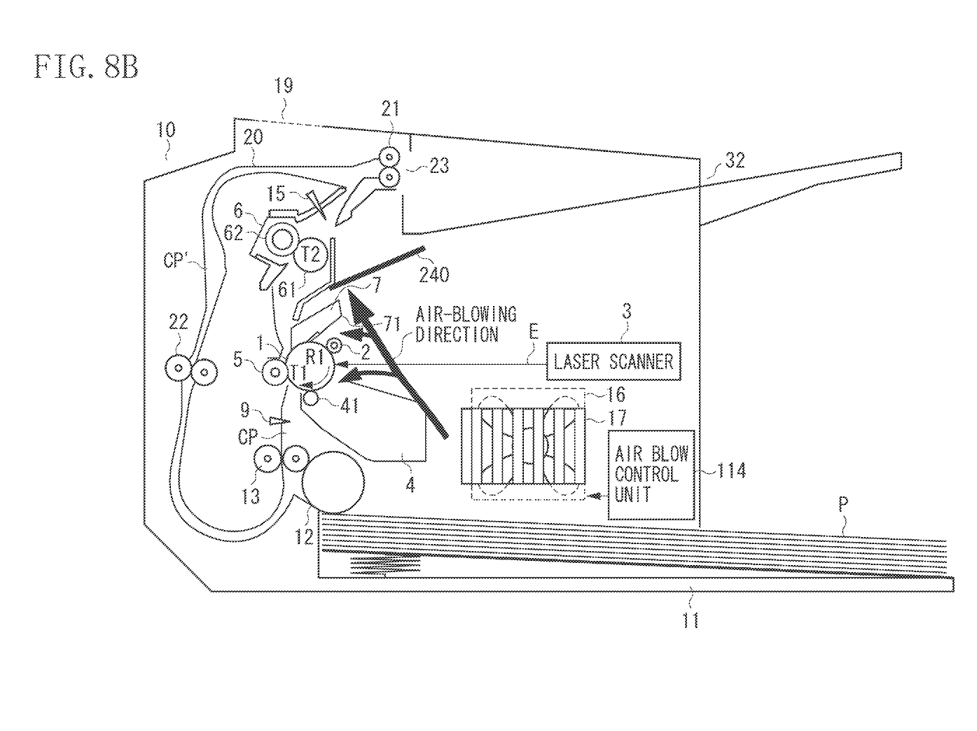

As another configuration of the present exemplary embodiment, a blocking member 240 as illustrated in FIGS. 8A and 8B, which are schematic cross-sectional views of the image forming apparatus, may be substituted for the above-described blocking member 140. FIG. 8A illustrates the blocking member 240 on a first position at which the blocking member 240 does not block an air flow in the apparatus main body produced by the air blown from the cooling fan 16. FIG. 8B illustrates the blocking member 240 on a second position at which the blocking member 240 blocks the air flow in the apparatus main body produced by the air blown from the cooling fan 16. The blocking member 240 is configured to move by a mechanism similar to that of the blocking member 140, and control thereof is similar to the flowchart illustrated in FIG. 7.

A difference of the blocking member 240 from the blocking member 140 is that, if the blocking member 240 is placed on the second position, the air is blown toward the developing container 4 and the cleaner 7 in the periphery of the photosensitive drum 1 in the apparatus. Therefore, during a period in which the cooling fan 16 is driven, the cooling fan 16 can cool the developing container 4 and the cleaner 7 in the periphery of the photosensitive drum 1 in the apparatus which have substantially no relation to the curl of the sheet material P, and can efficiently cool an interior of the apparatus.

In addition, in the case of a print job in which there is a certain level of interval between the sheets, energization of the solenoid 150 may be canceled in a period since the leading edge of the next sheet material P has been detected by the top sensor 9 after the trailing edge of the sheet material P has passed through the sheet discharge sensor until the predetermined time has elapsed, as in the case of the second exemplary embodiment.

As described above, according to the present exemplary embodiment, the air blow by the cooling fan 16 is stopped at least for a period during which the sheet material P is likely to curl if the air blow is performed by the cooling fan 16, namely, for a period during which the sheet material P passes through the fixing nip portion T2, during the printing operation period in the one-sided printing. Further, in the printing operation period, the fan is driven before the first sheet of the job reaches the fixing nip portion T2 and after the trailing edge of the last sheet of the job has passed through the sheet discharge sensor. Therefore, even in the print job in which there is a certain level of interval between the sheets, a time period in which air is blown into the apparatus by the cooling fan 16 is increased as far as possible.

Therefore, according to the present exemplary embodiment, in the image forming apparatus including the air blowing unit for producing an air flow in the sheet conveying path on the downstream side of the fixing nip portion in the sheet conveying direction, the apparatus can be cooled while suppressing occurrence of curl on the sheet, similar to the first exemplary embodiment.

In the case that the air blow into the apparatus is stopped by stopping the cooling fan, the fan itself rotates for a while due to an inertia even after control to stop the fun is performed, and accordingly it is necessary to perform the control to stop the fan well in advance. In contrast, in the case that the air blow into the apparatus is blocked by the blocking member 140, the air blow can be blocked more quickly by the blocking member 140, as compared with when the fan is stopped. Therefore, according to the present exemplary embodiment, control to blow the air into the apparatus just before the sheet material enters into the fixing nip portion can be easily performed, and prevention of excessive temperature rise in the apparatus becomes easier.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-226026 filed Oct. 13, 2011, which is hereby incorporated by reference herein in its entirety.

What is claimed is:

1. An image forming apparatus comprising:
a fixing unit configured to heat a recording material on which a toner image is formed to fix the toner image on the recording material, the fixing unit arranged on a conveying path in which the recording material on which the image is form is conveyed;
an air blowing unit configured to produce an air flow in a portion on a downstream side of the fixing unit in a conveying direction on the conveying path by blowing air; and
a control unit configured to control an amount of flowing air of the air flow produced in the portion on the downstream side of the fixing unit in the conveying direction of the conveying path,
wherein the image forming apparatus is capable of executing a first mode for forming an image on only a side of a recording material and discharging the recording material and a second mode for forming an image on both sides of a recording material and discharging the recording material, and
wherein, in a period that the first mode is executed, with respect to a recording material on which an image is formed, the control unit controls the air blowing unit such that the amount of flowing air becomes a first amount of flowing air in a period during which the recording material is conveyed on the conveying path and before a leading edge of the recording material reaches the fixing unit, and controls the air blowing unit such that the amount of flowing air becomes a second amount of flowing air smaller than the first amount of flowing air in a period during which the recording material passes through the fixing unit, and in a period that the second mode is executed, the control unit controls the air blowing unit such that the amount of flowing air becomes a third amount of flowing air larger than the second amount of flowing air for at least a period during which a recording material on which an image is formed passes through the fixing unit.

2. The image forming apparatus according to claim 1, wherein, in the period that the first mode is executed, with respect to a recording material on which an image is formed, the control unit controls the air blowing unit such that the amount of flowing air becomes the first amount of flowing air in a period during which the recording material is conveyed on the conveying path and after a trailing edge of the recording material has passed through the fixing unit.

3. The image forming apparatus according to claim 1, wherein, in the period that the first mode is executed, with respect to a recording material on which an image is formed, the control unit drives the air blowing unit in a period during which the recording material is conveyed on the conveying path and before the recording material passes through the fixing unit, and stops driving of the air blowing unit in a period during which the recording material passes through the fixing unit.

4. The image forming apparatus according to claim 1, wherein, in the period in which the first mode is executed, with respect to a recording material on which an image is formed, the control unit drives the air blowing unit at a first amount of blown air in a period during which the recording material is conveyed on the conveying path and before the recording material passes through the fixing unit, and drives the air blowing unit at a second amount of blown air smaller than the first amount of blown air in a period during which the recording material passes through the fixing unit.

5. The image forming apparatus according to claim 1, further comprising:
a restricting member configured to restrict air blown by the air blowing unit into in the portion on the downstream side of the fixing unit in the conveying direction on the conveying path,
wherein the restricting member is movable between a first position at which the air blow is not restricted and a second position at which the air blow is restricted, and wherein, with respect to a recording material on which an image is formed, the control unit arranges the restricting member on the second position in a period during which the recording material is conveyed on the conveying path and before the recording material passes through the fixing unit, and arranges the restricting member on the first position in a period during which the recording material passes through the fixing unit.

6. The image forming apparatus according to claim 3, further comprising:
an image forming member configured to form a toner image on a recording material,
wherein the image forming member is cooled by air blown by the air blowing unit.

7. The image forming apparatus according to claim 5, further comprising:
an image forming member configured to form a toner image on a recording material,
wherein the image forming member is cooled by air blown by the air blowing unit, and the image forming member is cooled by air blown by the air blowing unit in a state in which the restricting member is arranged on the first position, and in a state in which the blocking member is arranged on the second position.

8. The image forming apparatus according to claim 1, further comprising:
a leading edge detection unit configured to detect a leading edge of a recording material on an upstream side than a transfer unit configured to transfer a toner image onto the recording material in the conveying direction,
wherein the control unit changes the amount of flowing air of the air flow produced in the portion on the downstream side of the fixing unit in the conveying direction of the conveying path, from the first amount of flowing air to the second amount of flowing air, based on an output from the leading edge detection unit.

9. The image forming apparatus according to claim 2, further comprising:
a trailing edge detection unit configured to detect a trailing edge of a recording material on a downstream side than the fixing unit in the conveying direction,
wherein the control unit changes the amount of flowing air of the air flow produced in the portion on the downstream side of the fixing unit in the conveying direction of the conveying path, from the second amount of flowing air to the first amount of flowing air, based on an output from the trailing edge detection unit.

10. An image forming apparatus comprising:
a fixing unit configured to heat a recording material on which a toner image is formed to fix the toner image on the recording material, the fixing unit arranged on a conveying path in which the recording material on which the image is form is conveyed;
an air blowing unit configured to produce an air flow in a portion on a downstream side of the fixing unit in a conveying direction on the conveying path by blowing air; and
a control unit configured to control an amount of flowing air of the air flow produced in the portion on the downstream side of the fixing unit in the conveying direction of the conveying path,
wherein the image forming apparatus is capable of forming an image only on a side of a recording material and discharging the recording material, and
wherein, with respect to a recording material on which an image is formed, the control unit drives the air blowing unit in a period during which the recording material is conveyed on the conveying path and before a leading edge of the recording material reaches the fixing unit, stops driving of the air blowing unit in a period during which the recording material passes through the fixing unit, and drives the air blowing unit in a period during which the recording material is conveyed on the conveying path and after a trailing edge of the recording material has passed through the fixing unit.

11. The image forming apparatus according to claim 10, further comprising:
a leading edge detection unit configured to detect a leading edge of a recording material on an upstream side than a transfer unit configured to transfer a toner image onto the recording material in the conveying direction,
a trailing edge detection unit configured to detect a trailing edge of a recording material on a downstream side than the fixing unit in the conveying direction,
wherein the control unit stops driving of the air blowing unit based on an output from the leading edge detection unit, and then, starts driving of the air blowing unit based on an output from the trailing edge detection unit.

12. An image forming apparatus comprising:
a fixing unit configured to heat a recording material on which a toner image is formed to fix the toner image on the recording material, the fixing unit arranged on a conveying path in which the recording material on which the image is form is conveyed;
an air blowing unit configured to produce an air flow in a portion on a downstream side of the fixing unit in a conveying direction on the conveying path by blowing air; and
an air blowing unit configured to produce an air flow in a portion on a downstream side of the fixing unit in a conveying direction on the conveying path by blowing air; and
wherein the image forming apparatus is capable of forming an image only on a side of a recording material and discharging the recording material, and
wherein, while execution of an image forming job for performing image formation on a plurality of recording materials is in progress, the control unit, with respect to each recording material on which an image is formed, controls the air blowing unit such that the amount of flowing air becomes a first amount of flowing air in a period during which the recording material is conveyed on the conveying path and before a leading edge of the recording material reaches the fixing unit, controls the air blowing unit such that the amount of flowing air becomes a second amount of flowing air smaller than the first amount of flowing air in a period during which the recording material passes through the fixing unit, and controls the air blowing unit such that the amount of flowing air becomes the first amount of flowing air in a period after a trailing edge of the recording material has passed through the fixing unit and before a leading edge of a next recording material reaches the fixing unit.
